(19) United States
(12) Patent Application Publication
(10) Pub. No.: US 2013/0187354 A1
(43) Pub. Date: Jul. 25, 2013

(54) STAIRWAY ASSEMBLY FOR A MACHINE

(71) Applicant: Vijay Venkataraman, Chennai (IN)

(72) Inventor: Vijay Venkataraman, Chennai (IN)

(73) Assignee: Caterpillar Inc., Peoria, IL (US)

(21) Appl. No.: 13/356,713

(22) Filed: Jan. 24, 2012

(51) Int. Cl. B60R 3/00

(52) U.S. Cl. 280/166

(57) ABSTRACT

A stairway having a first section hingedly connected to the platform by a first pin joint. The first section is connected to the platform at a proximal end. The first pin joint allows for a rotation of the first section about a first hinge axis. Further, a second section is hingedly connected to the first section by a second pin joint. The second section is connected at a distal end of the first section. The second pin joint allows for a rotation of the second section about a second hinge axis. An actuator is pivotally connected to the platform by a first joint and to the distal end of the first section by a second joint.

### TECHNICAL FIELD

The present disclosure relates to a stairway assembly for a machine and more particularly to a stairway configured to be folded.

### BACKGROUND

Large machines, such as a power shovel used in construction and mining applications generally have an operator station positioned at an elevation from the ground. The operator station may include means to control the various functions of the machine. The operator may access the operator station by climbing a stairway, which is typically disposed adjacent to the operator station. The stairway may be provided along a lateral side of the machine. During operation, some of the vibrations induced in the machine may be transmitted to the stairway. This may cause the stairway to collide and bounce of the side of the machine and cause some damage.

Published patent application JP2009263876A discloses a stairway assembly for a machine. The stairway assembly includes a hydraulic mechanism to lift or lower a foldable stairway. The stairway assembly also includes a locking mechanism operatively connected to the hydraulic mechanism to move a lock lever associated with the locking mechanism to a release position during operation.

### SUMMARY

In one aspect, the present disclosure provides a stairway for a platform. The stairway includes a first section hingedly connected to the platform by a first pin joint. The first section is connected to the platform at a proximal end of the first section. The first pin joint allows for a rotation of the first section about a first hinge axis. Further, a second section is hingedly connected to the first section by a second pin joint. The second section is connected at a distal end of the first section. The second pin joint allows for a rotation of the second section about a second hinge axis. An actuator is pivotally connected to the platform by a first joint and to the distal end of the first section by a second joint.

In another aspect, the present disclosure provides a stairway assembly adapted to be used in a machine with the platform elevated from a ground. The stairway assembly includes a controller in connection with an operator switch. The controller is configured to generate an operator signal on activation of the operator switch. Further, a hydraulic circuit is provided to supply a hydraulic fluid based on the operator signal. The stairway assembly further includes the stairway. The stairway includes the first section hingedly connected to the platform by the first pin joint. The first section is connected to the platform at the proximal end of the first section. The first pin joint allows for the rotation of the first section about the first hinge axis. Further, the second section is hingedly connected to the first section by the second pin joint. The second section is connected at the distal end of the first section. The second pin joint allows for the rotation of the second section about the second hinge axis. An actuator is pivotally connected to the platform by the first joint and to the distal end of the first section by the second joint. The actuator is in fluid communication with the hydraulic circuit to receive the hydraulic fluid. Further, the pushrod is pivotally connected to the platform at the first end and to the second section at the second end.

In yet another aspect, the present disclosure provides a machine. The machine includes an operator station disposed at an elevation from the ground, the operator station being accessible via the platform. The machine also includes the stairway mounted to the platform. The stairway includes the first section hingedly connected to the platform by the first pin joint. The first section is connected to the platform at the proximal end of the first section. The first pin joint allows for the rotation of the first section about the first hinge axis. Further, the second section is hingedly connected to the first section by the second pin joint. The second section is connected at the distal end of the first section. The second pin joint allows for the rotation of the second section about the second hinge axis. An actuator is pivotally connected to the platform by the first joint and to the distal end of the first section by the second joint. Further, the pushrod is pivotally connected to the platform at a first end and to the second section at a second end. The pushrod is configured to provide a constrained movement of the second section with respect to the first section between an operating state and a folded state of the stairway.

Other features and aspects of this disclosure will be apparent from the following description and the accompanying drawings.

### BRIEF DESCRIPTION OF THE DRAWINGS

FIG. 1 illustrates a perspective view of a machine;

FIG. 2 illustrates a side view of the machine of FIG. 1;

FIG. 3 illustrates a perspective view of a stairway;

FIG. 4 illustrates a side view of the stairway of FIG. 3 in an operating state;

FIG. 5 illustrates a side view of the stairway of FIG. 3 in a folded state;

FIG. 6 illustrates a block diagram for a stairway assembly; and

FIG. 7 illustrates a side view of the stairway of FIG. 3 in an interim state.

### DETAILED DESCRIPTION

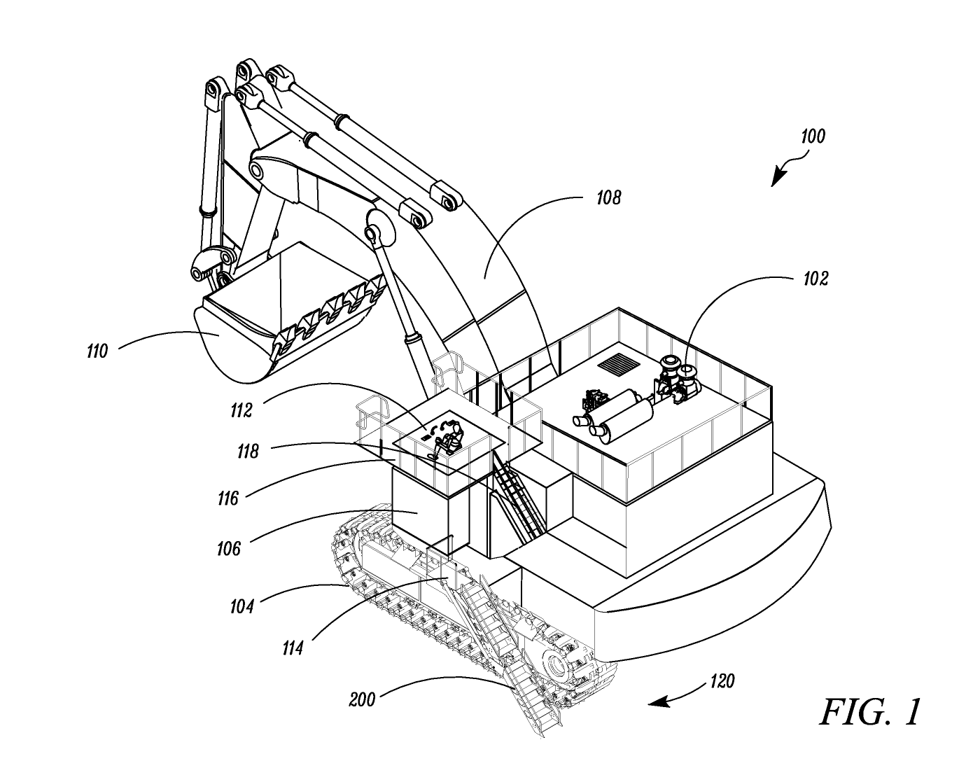

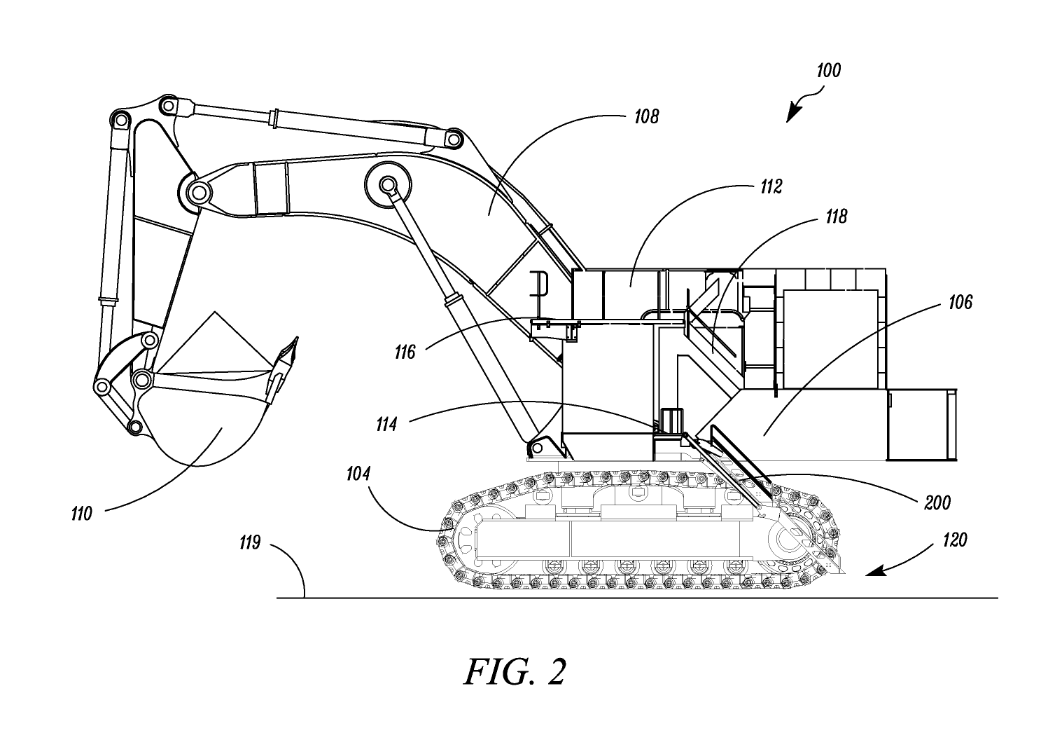

The present disclosure will now be described in detail with reference being made to accompanying figures. A machine 100 in which disclosed embodiments may be implemented is illustrated in FIGS. 1-2. The machine 100 may be generically described as any machine having an operator station positioned at an elevation from ground. In the illustrated embodiment, the machine 100 is a mining shovel. However, the machine 100 may be any machine used in industries like mining or construction, for example, a wheel loader, an excavator, a motor grader, a cold planer, a backhoe loader, a track type tractor, a dump truck, a diesel locomotive or the like. The machine 100 of the present disclosure may have dimensions depending on various factors, such as, application, type, etc.

The machine 100 includes a power source 102 for driving various components in the machine 100. The power source 102 may be an internal combustion engine such as petrol engine or a diesel engine, an electrical source like a series of batteries, an overhead conductor or the like. The machine 100 includes tracks 104 as ground engaging members to propel and maneuver the machine 100. Alternatively, the machine 100 may use a set of drive wheels as the ground engaging members. The machine 100 may further include a chassis 106 to support various components of the machine 100. Further, the machine 100 may include a linkage arm 108 supported on the chassis 106 from one end and a bucket 110 disposed at other end of the linkage arm 108.

The machine 100 may further include an operator station 112. The operator station 112 may be defined in the form of an enclosure and supported on the chassis 106. An operator may control the various functions of the machine 100 through the operator station 112 by issuing commands using controls means, such as joysticks, levers, touch based user interfaces, etc. provided in the operator station 112. The operator station 112 may be accessible through a platform 114 in the machine 100. As illustrated, the machine 100 of the present disclosure may include a sidewalk 116 adjacent to the operator station 112 which is reachable via the platform 114 by an auxiliary stairway 118.

The platform 114 may be disposed at an elevation from a ground 119. In an exemplary configuration, the platform 114 may be at an elevation in the range of about 2-4 meters from the ground 119. To provide the operator with means to reach the operator station 112, the machine 100 includes a stairway assembly 120. The stairway assembly 120 includes a stairway 200 positioned along any lateral side in the machine 100. The stairway 200 may be adapted to be used by the operator to access the operator station 112. The operator may ascend to the operator station 112 by climbing the stairway 200 to reach the platform 114 and further the auxiliary stairway 118 and walking down the sidewalk 116. The stairway 200 of the present disclosure may be configured to be put in either an operating state or a folded state.

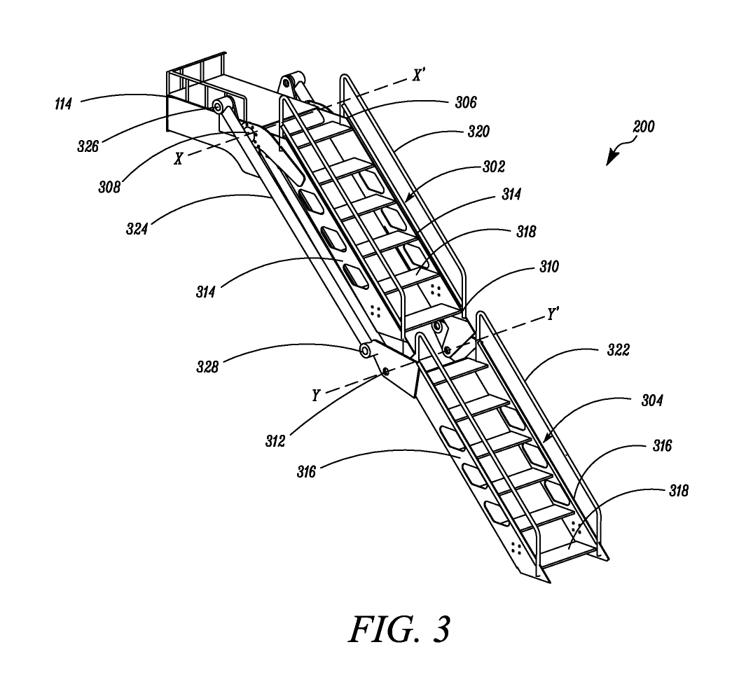

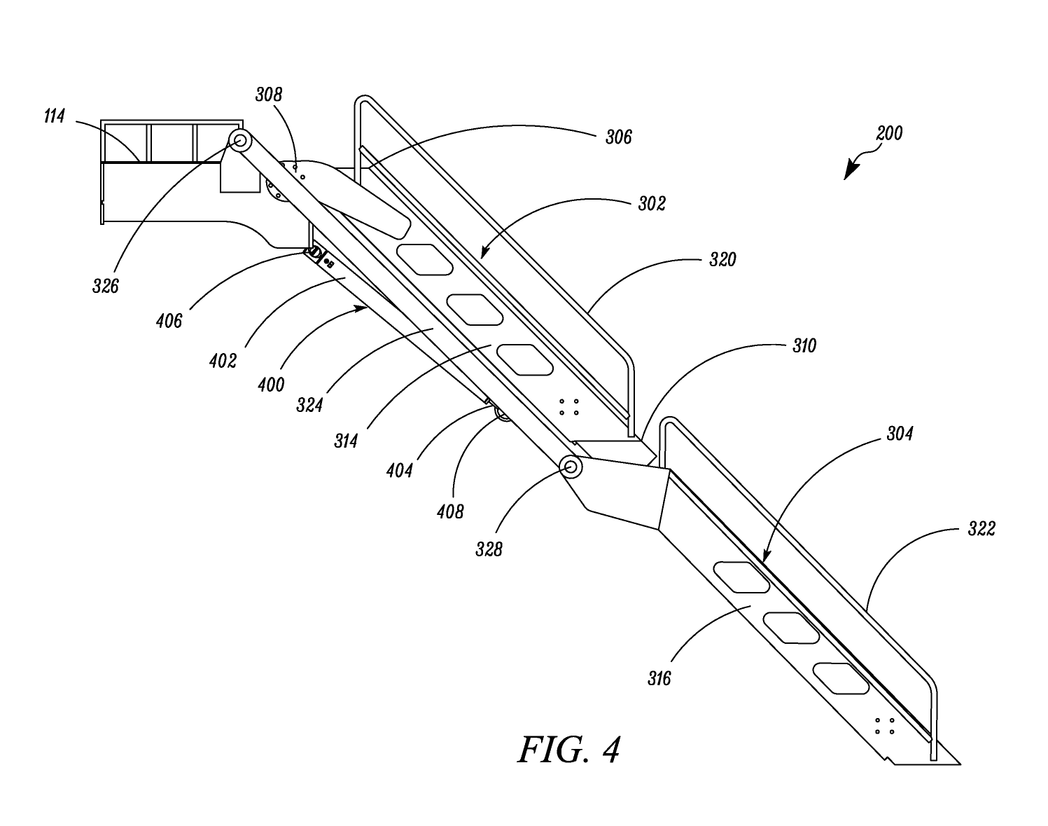

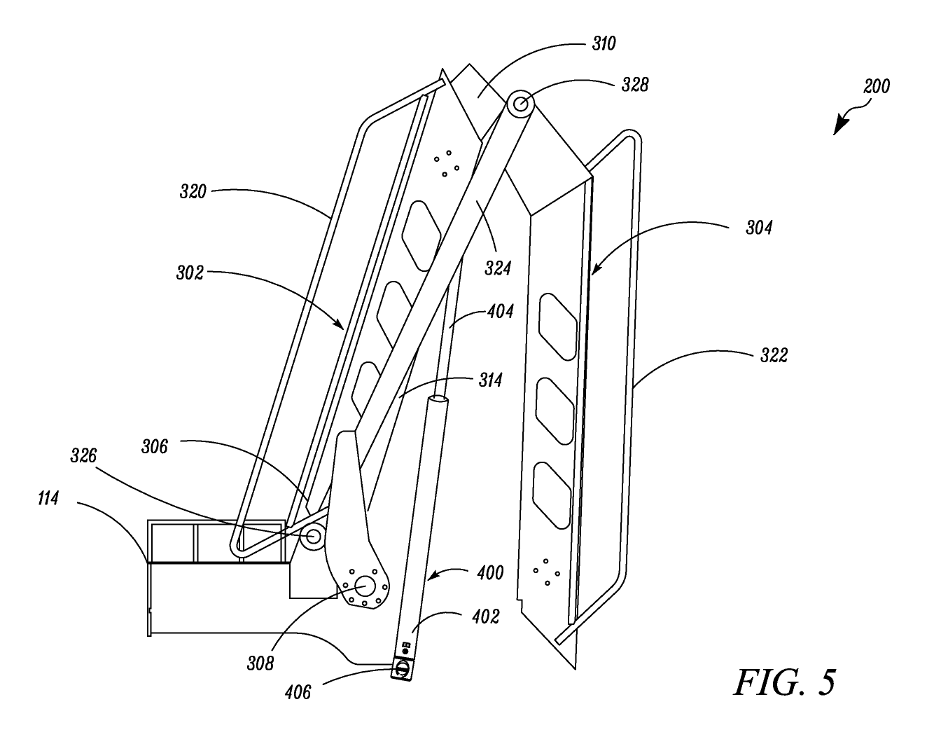

In the accompanied drawings, FIG. 3 illustrates a perspective view of the stairway 200. Further, FIG. 4 and FIG. 5 illustrate side views of the stairway 200 in the operating state and the folded state respectively. The stairway 200 may be divided into a plurality of sections, so as to put the stairway 200 from the operating state to the folded state. For the purpose of the present disclosure, the stairway 200 may include a first section 302 and a second section 304. In an exemplary configuration, the first section 302 and the second section 304 may each have a length in the range of about 1.5-2.5 meters. However, it will be apparent to a person skilled in the art that the length of the first section 302 and the second section 304 may vary depending on the size of the machine 100.

The first section 302 may be hingedly connected to the platform 114 from a proximal end 306 of the first section 302. The first section 302 may be connected to the platform 114 by a first pin joint 308. The first pin joint 308 defines a first hinge axis XX′ for rotation of the first section 302 with respect to the platform 114. Similarly, the second section 304 may be hingedly connected to a distal end 310 of the first section 302. The second section 304 may be connected to the first section 302 by a second pin joint 312. The second pin joint 312 defines a second hinge axis YY′ for relative rotation of the second section 304 with respect to the first section 302.

The first section 302 and the second section 304 may include a first pair of side plates 314 and a second pair of side plates 316, respectively. The stairway 200 may also include a plurality of steps 318 disposed between the first pair of side plates 314 and the second pair of side plates 316. The plurality of steps 318 may be spaced lengthwise in the stairway 200. Further, the stairway 200 may include a first pair of side rails 320 affixed to and extending along the length of the first section 302 and a second pair of side rails 322 affixed to and extending along the length of the second section 304.

Further, the stairway 200 may include a pushrod 324 to provide a connection between the platform 114 and the second section 304. In an embodiment, the stairway 200 may include two pushrods 324 disposed along each side. The pushrod 324 may be pivotally connected to the platform 114 at a first end 326 and pivotally connected to the second section 304 at a second end 328. The pushrod 324 may be connected from both the first end 326 and the second end 328 by means of pin joints. As illustrated, the second end 328 may be located in the second section 304 near the second pin joint 312 of the first section 302. In an exemplary configuration, the pushrod 324 may have a length in the range of about 1.5-2.5 meters.

Referring to FIGS. 4-5, the stairway 200 may also include an actuator 400 disposed between the platform 114 and the first section 302. The actuator 400 may act as a hydraulic link in the stairway 200. The actuator 400 may include a cylinder 402 and a piston 404. The piston 404 may be configured to move linearly, extend and refract, in the cylinder 402 of the actuator 400. Alternatively, the actuator 400 may be a linear hydraulic motor having an extendable rod moving linearly on being actuated. In an exemplary configuration, the piston 404 may extend and retract in a range varying from 1-2.5 meters.

The actuator 400 may be pivotally connected to the platform 114 at a first joint 406 and pivotally connected to the first section 302 at a second joint 408 of the stairway 200. The first joint 406 and the second joint 408 may also be pin joints disposed in the stairway 200. Specifically, the cylinder 402 of the actuator 400 may be pivotally connected to the platform 114 and the piston 404 of the actuator 400 may be pivotally connected to the distal end 310 of the first section 302. The extension or retraction of the piston 404 may result in raising or lowering of the distal end 310 and provide rotation of the first section 302 about the first hinge axis XX′ with respect to the platform 114.

The stairway 200 may also include a locking arrangement (not illustrated) for holding the stairway 200 in the operating state. The locking arrangement may also include the provision to adjust the inclination angle of the second section 304 with respect to the first section 302. The locking arrangement may be a mechanical stopper having one face resting on the platform 114 and another face bolted to the first section 302 of the stairway 200. Further, a clamping arrangement (not illustrated) may be provided to maintain the stairway 200 in the folded state. The clamping arrangement may fasten the first section 302 or the second section 304 against the platform 114. Further, the clamping arrangement may be used to lock the second section 304 against the first section 302, when the stairway 200 is in a folded state.

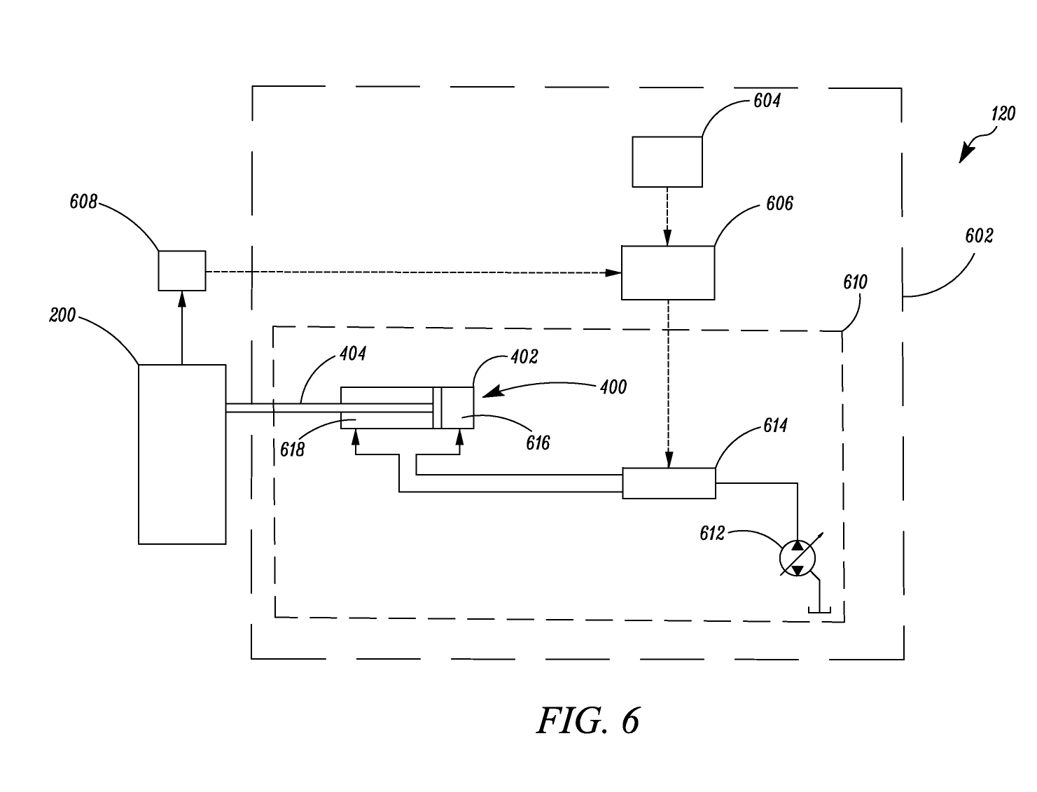

Moving on, FIG. 6 illustrates a schematic for the stairway assembly 120 of the present disclosure. The stairway assembly 120 may include the stairway 200 and a control unit 602. As illustrated, the control unit 602 may include an operator switch 604, which may be in the form of lever, push button, etc. disposed in the machine 100. The operator switch 604 may be positioned in the operator station 112 or so as to be accessible by the operator from the ground 116. Alternatively, the operator switch 604 may be in the form of a remote control operated by the operator.

The control unit 602 may further include a controller 606 to generate an operator signal, when the operator switch 604 is activated. The controller 606 may be a combination of, but not limited to, a set of instructions, a Random Access Memory (RAM), a Read Only Memory (ROM), flash memory, a data structure, and the like. The controller 606 may further be configured to detect whether the stairway 200 is in the operating state or the folded state. This may be achieved by means of one or more sensors 608 associated with the stairway 200.

Further, the control unit 602 may include a hydraulic circuit 610. The hydraulic circuit 610 may include a pump 612 providing a supply of hydraulic fluid. For the purpose of the present disclosure, the pump 612 may be an electric motor pump drawing power from battery in the machine 100. Alternatively, the pump 612 may be a variable displacement hydraulic pump. The hydraulic circuit 610 may further include a control valve 614 disposed in connection with the controller 606. The control valve 614 may be arranged to receive the operator signal from the controller 606. The control valve 614 may control the supply of the hydraulic fluid based at least in part on the operator signal.

The hydraulic fluid from the control valve 614 may be supplied to the actuator 400. The piston 404 may move in the cylinder 402 based on the received supply of the hydraulic fluid in the actuator 400. In the actuator 400, the cylinder 402 may be divided into a first side 616 and a second side 618, on either side of the piston 404 in the cylinder 402. The piston 404 may extend in the cylinder 402, when the hydraulic fluid is received in the first side 616 of the cylinder 402. Conversely, when the hydraulic fluid is received in the second side 618, the piston 404 may retract in the cylinder 402.

### INDUSTRIAL APPLICABILITY

The present disclosure is applicable to machines, for example, a power shovel, such as a mining shovel, which are commonly used in mines, construction sites and quarries. Typically, these machines have high payload capabilities and therefore are required to have large size. Due to the large size of such machines and for the reason to provide a good field of view, the operator station in such machines may generally be positioned at a high elevation from the ground. The operator station may be accessible by an operator via a stairway disposed in the machine.

The stairway may typically be provided along a lateral side of the machine. The stairway may extend from one of the sides and take up some of the installation space in the machine. During operation of the machine, due to the vibrations induced by the power source or the operating conditions, the stairway may vibrate along with the chassis of the machine. This may cause the stairway to strike the lateral sides of the machine to which the stairway is installed and lead to some damage.

To minimize such problems, the stairway 200 of the present disclosure is configured to be switched from the operating state to the folded state. The stairway assembly 120 enables the operator to switch the stairway 200 from the operating state to the folded state and vice versa, as required. This way, the operator may put the stairway 200 to the operating state, when need to reach the operator station 112 and to the folded state, when not in use. During operation, as the stairway 200 may be put to the folded state. This reduces the space taken up by the stairway 200 in the machine 100.

The operator may put the stairway 200 in either the operating state or the folded state by activating the operator switch 604 in the stairway assembly 120. The controller 606 may determine whether the stairway is already in the operating state or the folded state. Further, the controller 606 may generate the operator signal to put the stairway 200 in the folded state, if the stairway 200 is already in the operating state or vice versa.

In particular, when the controller 606 determines that the stairway 200 is in the operating state, the operator switch 604 generates the operator signal to put the stairway 200 to the folded state. The operator signal may instruct the control valve 614 to pass the pressurized hydraulic fluid from the pump 612 to the first side 616 in the cylinder 402 of the actuator 400. The hydraulic fluid received in the first side 616 may cause the piston 404 to extend in a direction away from the inside of the cylinder 402. Subsequently, the linear motion of the piston 404 may be translated to the rotational motion of the distal end 310 of the first section 302 about the first hinge axis XX′.

Due to the hinged coupling of the first section 302 with the second section 304 about the second pin joint 312, the rotational movement of the first section 302 may impart rotational movement to the second section 304 about the second hinge axis YY′. This movement of the second section 304 may be constrained by the pushrod 324 in the stairway 200, causing the second section 304 move with the first section 302 from the substantially inclined position to the vertical position. Finally, the second section 304 may abut with the first section 302, ultimately putting the stairway 200 in the folded state as illustrated in FIG. 4.

Conversely, when the controller 606 determines the stairway 200 to be in the folded state, the operator switch 604 generates the operator signal to put the stairway 200 to the operating state. The operator signal may instruct the control valve 614 to allow the hydraulic fluid to flow from the pump 612 to the second side 618 in the cylinder 402 of the actuator 400. This makes the piston 404 to retract inside the cylinder 402, causing the distal end 310 to rotate about the second hinge axis YY′. Further, the second section 304 may move with the first section 302 from the substantially vertical position to the inclined position due to constrained movement provided by the pushrod 324 and ultimately putting the stairway 200 in the operating state as illustrated in FIG. 5.

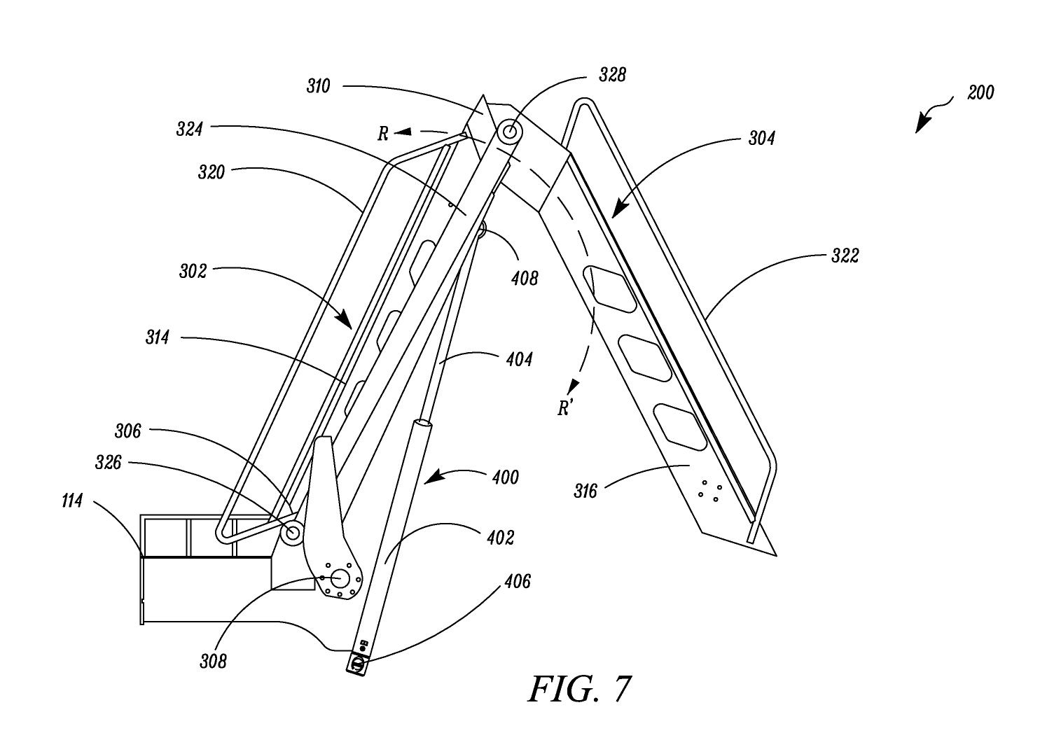

It is characteristic that the stairway 200 may fold or unfold in a zigzag fashion by rotating about adjacent hinged axes XX′ and YY′ of rotation in opposite directions. FIG. 7 illustrates the stairway 200 in any one of an intermediate state between the operating state and the folded state. Further, the rotational movement of the stairway 200 is depicted by RR′. The stairway 200 moves in the direction R-R′, when switched from the folded state to the operating state and moves in the direction R′-R, when switched from the operating state to the folded state. The locking arrangement and the clamping arrangement may relieve the hydraulic circuit 610 to provide a constant supply of the hydraulic fluid to maintain the stairway 200 in the operating state or the folded state.

Further, in an embodiment, the actuator 400 may provide some dampening effect for the vibrations transmitted from the platform 114, connected to the chassis 106 in the machine 100, to the stairway 200. These vibrations may be passed from the actuator 400 to the hydraulic circuit 610 by the hydraulic fluid. The hydraulic circuit 610 may absorb some vibrations through an accumulator (not illustrated). Thus, the stairway assembly 120 of the present disclosure may also help to minimize the issue of vibrations in the stairway 200 to some extent.

Although the embodiments of this disclosure as described herein may be incorporated without departing from the scope of the following claims, it will be apparent to those skilled in the art that various modifications and variations can be made. Other embodiments will be apparent to those skilled in the art from consideration of the specification and practice of the disclosure. It is intended that the specification and examples be considered as exemplary only, with a true scope being indicated by the following claims and their equivalents.

What is claimed is:

1. A stairway for a platform, the stairway comprising:
a first section hingedly connected to the platform by a first pin joint at a proximal end of the first section, the first pin joint allows a rotation of the first section about a first hinge axis;
a second section hingedly connected to the first section by a second pin joint at a distal end of the first section, the second pin joint allows a rotation of the second section about a second hinge axis; and
an actuator pivotally connected to the platform by a first joint and to the distal end of the first section by a second joint.

2. The stairway of claim 1, wherein the actuator includes a cylinder and a piston disposed in the cylinder.

3. The stairway of claim 2, wherein the piston is adapted to extend and contract in the cylinder to raise and lower the distal end of the first section with respect to the platform.

4. The stairway of claim 1, wherein the actuator is a linear hydraulic motor.

5. The stairway of claim 1 further including a pushrod, wherein the pushrod is pivotally connected to the platform at a first end and to the second section at a second end.

6. The stairway of claim 5, wherein the pushrod is configured to provide a constrained movement of the second section with respect to the first section between an operating state and a folded state.

7. The stairway of claim 1, wherein the first section includes a first pair of side plates with a plurality of steps disposed therebetween.

8. The stairway of claim 1, wherein the second section includes a second pair of side plates with a plurality of steps disposed therebetween.

9. The stairway of claim 1 further including a first pair of side rails and a second pair of side rails, wherein the first pair of side rails and the second pair of side rails are disposed on the first section and the second section respectively.

10. A stairway assembly adapted to be used in a machine with a platform elevated from a ground, the stairway assembly comprising:
a controller in connection with an operator switch, the controller is configured to generate an operator signal on activation of the operator switch;
a hydraulic circuit configured to supply a hydraulic fluid based on the operator signal; and
a stairway mounted to the platform, the stairway including:
a first section hingedly connected to the platform by a first pin joint at a proximal end of the first section,
a second section hingedly connected to the first section by a second pin joint at a distal end of the first section,
an actuator pivotally connected to the platform by a first joint and to the distal end of the first section by a second joint, the actuator is in fluid communication with the hydraulic circuit to receive the hydraulic fluid, and
a pushrod pivotally connected to the platform at a first end and to the second section at a second end.

11. The stairway assembly of claim 10, wherein the pushrod is configured to provide a constrained movement of the second section with respect to the first section between an operating state and a folded state of the stairway.

12. The stairway assembly of claim 10 further including one or more sensors in connection with the controller to determine whether the stairway is in an operating state or a folded state.

13. The stairway assembly of claim 10, wherein the hydraulic circuit includes a pump to pressurize the hydraulic fluid and a control valve to supply the hydraulic fluid based at least in part on the operator signal.

14. The stairway assembly of claim 10, wherein the actuator includes a cylinder and a piston disposed in the cylinder.

15. The stairway assembly of claim 14, wherein the piston is adapted to extend and contract in the cylinder based on the supply of the hydraulic fluid, so as to raise and lower the distal end of the first section with respect to the platform.

16. A machine comprising:
an operator station disposed at an elevation from a ground, the operator station being accessible via a platform; and
a stairway mounted to the platform, the stairway including:
a first section hingedly connected to the platform by a first pin joint at a proximal end of the first section,
a second section hingedly connected to the first section by a second pin joint at a distal end of the first section,
an actuator pivotally connected to the platform by a first joint and to the distal end of the first section by a second joint, and
a pushrod pivotally connected to the platform at a first end and to the second section at a second end.

17. The machine of claim 16, wherein the pushrod is configured to provide a constrained movement of the second section with respect to the first section between an operating state and a folded state of the stairway.

18. The machine of claim 16 further including a control unit, the control unit including:
a controller in connection with an operator switch, the controller is configured to generate an operator signal on activation of the operator switch; and
a hydraulic circuit including a pump to pump a hydraulic fluid and a control valve to supply a hydraulic fluid to the actuator based at least in part on the operator signal.

19. The machine of claim 18 further including one or more sensors in connection with the controller to determine whether the stairway is in an operating state or a folded state.

20. The machine of claim 18, wherein the actuator includes a cylinder and a piston adapted to extend or contract in the cylinder based on the supply of the hydraulic fluid, so as to raise or lower the distal end of the first section with respect to the platform.
